(19) United States
(12) Patent Application Publication
(10) Pub. No.: US 2020/0070215 A1
(43) Pub. Date: Mar. 5, 2020

(54) PORTABLE UTENSIL WASHER

(71) Applicant: Kerry Mosser, Austin, TX (US)

(72) Inventor: Kerry Mosser, Austin, TX (US)

(21) Appl. No.: 16/116,534

(22) Filed: Aug. 29, 2018

(51) Int. Cl. B08B 7/04; A47L 17/00; A47L 15/37; B08B 1/00

(52) U.S. Cl. CPC B08B 7/04; A47L 17/00; A47L 2301/08; B08B 1/002; A47L 15/37

(57) ABSTRACT

The present disclosure describes devices and methods for washing various utensils. The devices may be portable and the utensils may include assorted eating utensils. A device configured for washing utensils may include a vessel or container, a removable component, such as a cap or lid, coupled to the container, and a cleaning component protruding in the container. The cleaning component may be coupled to the under-side of the removable component. The cleaning component may include an elongated brush comprising a plurality of bristles. The container may comprise a cylindrical bottle, which may be insulated. The cleaning component may be reversibly coupled to the removable component by, for example, using complementary threaded portions defined by the two components.

### TECHNICAL FIELD

The present disclosure pertains to devices and methods for washing small objects such as utensils. Particular implementations include portable washing devices comprising a container with an internal cleaning component, such as a brush.

### BACKGROUND

Washing eating utensils can be cumbersome and time-consuming, especially in settings not equipped with traditional washing equipment. For example, washing eating utensils while camping can be particularly difficult. In such settings, utensils are typically washed and dried one-by-one without a sink or faucet, and water may be in limited supply. Likewise, washing eating utensils in households that lack a dishwasher can necessitate a significant volume of water, time, and repetitive effort. Many households lack an automatic dishwasher for reasons such as unaffordability or lack of space. Accordingly, a portable device configured to facilitate utensil washing in settings that lack automatic dishwashing equipment is needed.

### SUMMARY

The present disclosure describes devices and methods for washing small items, such as eating utensils, without needing a sink or dishwasher.

A washing device disclosed herein may include a container with a closeable opening and a cleaning component, with cleaning elements, that protrudes within the container. In some examples, the cleaning component may be held in a relatively fixed position in the interior of the container.

Example methods of washing items using the device may include the steps of placing items to be washed into the container and adding water or a cleaning solution, or both, to the container, in no particular order, and subsequently shaking or agitating the device such that the items contact the cleaning elements of a cleaning component within the container. In some examples, the method may also include adding soap.

Examples of such washing devices may include a container that is generally cylindrical in shape, such as the shape of a reusable water bottle. In some examples, the washing device may include a removable cap configured to close the closeable opening. In some examples, the cleaning component may comprise an elongated brush with bristles as cleaning elements.

In some examples, the cleaning component may be fixed or coupled to the under-side of a removable cap so that the cleaning component protrudes from the under-side of the removable cap and extends into the container when the cap is secured thereto, thus positioning the cleaning elements of the cleaning component inside the container such that, during the washing process, cleaning elements will contact the items to be washed (e.g., eating utensils) that are placed in the container.

This configuration may be accomplished using coupling configurations known in the art. It may be advantageous to couple the cleaning component to the removable cap in such a way that they can be coupled and uncoupled by an ordinary user (i.e., “reversibly coupled”) such that a user can uncouple the cleaning component from the cap and thereafter use the container for other purposes, e.g., carrying water, coffee, soup, or other liquids.

In some examples, the cleaning component may include a stem having a threaded portion configured to engage a complementary threaded portion located at the under-side of the removable cap in order to couple the cleaning component to the removable cap. In some examples, a push-button latch and release mechanism may be employed to couple and uncouple the cleaning component to and from the removable cap. In some examples, the cleaning component may include a male end, such as a stem, having a spring-loaded ball that protrudes out from the surface of the male end, can be pressed in to be substantially flush with the surface of the male end, and springs back into place (protruding out from the outer surface of the male end) after being released, and the under-side of the removable cap may include a protrusion configured to slideably receive the male end and a hole configured to receive the spring-loaded ball, thus locking the cleaning component into place. In such a configuration, pressing in the spring-loaded ball will allow removal of the cleaning component stem from the removable cap's protrusion. Alternatively, the spring-loaded ball may be located on a protrusion on the under-side of the removable cap and the cleaning component may be configured to slideably receive the protrusion and may include a hole configured to receive the protrusion's spring-loaded ball. Various other male-female type coupling configurations, including configurations known in the art, may be used to couple the cleaning component to the removable cap. In such configurations, the cleaning component may include a male portion and the removable cap may include a female portion configured to receive the male portion of the cleaning component. Alternatively, the removable cap may include a male portion and the cleaning component may include a female portion configured to receive the male portion of the removable cap.

In some examples, the cleaning component may be permanently fixed to the removable cap using a male-female coupling configuration and a bonding material, such as glue.

In some examples, the removable cap may define a through-hole such that the cleaning component can be inserted and removed therethrough. Various options can be used for closing or sealing the through-hole, including, for example, a cap, flip top, slide closure, etc. In some examples, the cleaning component in such implementations may include a cap at one end that may be configured to seal the through-hole upon insertion of the cleaning component into the container.

In some examples, the removable cap may define a through-hole through which a stem of a cleaning component may pass such that the cleaning component may be moved back and forth along the length of the interior of the container to achieve cleaning by way of a plunging action.

In some examples, various mechanisms to allow the cleaning component to be rotated to thereby achieve cleaning may be implemented.

In some examples, the removable cap may house an internal reservoir for holding liquid soap or a cleaning solution such as, for example, a soap-water mixture. Such a cap may include a closable opening for adding, and optionally pouring out, soap. Such a cap may also include a mechanism for releasing or injecting the contents of the internal reservoir into the interior of the container, such as a pump mechanism.

The inventive device may be used to wash common eating utensils, including but not limited to forks, spoons, and knives. The device may also be used to wash other utensils associated with kitchens and cooking, including but not limited to things such as butcher knives, bottle openers, wine bottle openers, can openers, reusable wine corks, prongs, tongs, corn on the cob holders, chopsticks, skewers, crab crackers, fondue forks, lobster picks, nutcrackers, whisks, etc. The inventive device may also be used to wash utensils that are not associated with eating or the kitchen. Such items include but are not limited to various medical and/or dental tools, instruments and/or small devices used for an assortment of applications ranging from routine dental cleanings to surgical operations. For example, the inventive device may be used to clean or sterilize forceps, scalpels, scissors, clamps, mirrors, probes, scalers, curettes, dental picker tools, etc. Other example items include hand tools and tool components used for auto-mechanical and/or construction applications. For example, the inventive device may be used to clean screwdrivers, wrenches, sockets, pliers, etc. The device may also be used to clean items such as jewelry, watches, pocketknives, etc. Various other applications will be apparent to ordinary users.

In some examples, the cleaning component may have a length of about 10 to 11 inches so that the full length of common eating utensils, including dinner knives, would contact the cleaning elements of the cleaning component during the washing process. In some embodiments, the cleaning component may have a length of about 12 to 13 inches so that the full length of common eating utensils as well as items such as large butcher knives would contact the cleaning component during the washing process. In some examples, the cleaning component may have a length of about 14 to 15 inches so that the full length of common eating utensils, butcher knives and most skewers would contact the cleaning component during the washing process. In some examples, the length of the cleaning component may be longer or shorter than the lengths listed above depending on the size of the items to be washed.

In some examples in which the removable cap defines a through-hole through which a stem of a cleaning component may pass such that the cleaning component can be moved back and forth along the length of the interior of the container to achieve cleaning by way of a plunging action, the length of the cleaning component may be greater than the length of the interior of the container to allow the cleaning component's cleaning elements, such as, for example, bristles, to reach to the bottom of the container and thus the bottom of the items to be cleaned with the plunging action. In such embodiments, cleaning elements may be located at or near the bottom end of the cleaning component. Cleaning elements may also be located elsewhere on the cleaning component.

In some examples, the cleaning component may have a width of about at least 50% of the width of the container. In some examples, the cleaning component may comprise cleaning elements of varying sizes. For example, a cleaning component may have bristles of varying lengths, varying widths, or varying lengths and widths. In some examples, the cleaning elements of the cleaning component can comprise bristles, segments of sponge, or segments of cloth.

In some examples, the container can comprise a cylindrical bottle having a volume of about 48 fluid oz. to about 72 fluid oz. In some examples, the container itself may comprise multiple parts, such as, for example a first part and a second part that may be readily coupled together and uncoupled.

Example methods of washing items with the device may include placing the items into a container and adding water or a cleaning solution, or both, to the container, in no particular order, and subsequently shaking or agitating the device such that the items contact cleaning elements of a cleaning component within the container. The method may also include adding soap. By using the washing device in accordance with implementations provided herein, a user may wash multiple items in less time than would typically be required if washing the items individually and/or in the absence of automatic washing equipment. In addition, using the washing device in accordance with implementations provided herein can help conserve water in settings in which potable water is limited or the user would like to minimize her use of potable water.

### BRIEF DESCRIPTION OF THE DRAWINGS

FIG. 1 is a perspective view of a washing device in accordance with principles of the present disclosure shown here in an unclosed state.

FIG. 2 is a perspective view of a cleaning component coupled with the removable cap of FIG. 1.

FIG. 3 is a perspective view of a coupling mechanism configured to couple a removable cap to a cleaning component in accordance with principles of the present disclosure.

FIG. 4 is a perspective view of another coupling mechanism configured to couple a removable cap to a cleaning component in accordance with principles of the present disclosure.

FIG. 5 is a perspective view of a closed washing device in accordance with principles of the present disclosure.

FIG. 6 is a perspective view of a container in accordance with principles of the present disclosure.

FIG. 7A is a front view of a removable cap and a cleaning component extending therethrough in accordance with principles of the present disclosure.

FIG. 7B is a perspective view of a top portion of the removable cap of FIG. 7A.

FIG. 8 is a front view of another open washing device in accordance with principles of the present disclosure.

FIG. 9 is a front view of another closed washing device in accordance with principles of the present disclosure.

FIG. 10 is a flow diagram of a method implemented in accordance with principles of the present disclosure.

### DESCRIPTION

The following description of certain embodiments is merely exemplary in nature and is in no way intended to limit the invention or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the present system. Moreover, for the purpose of clarity, detailed descriptions of certain features will not be discussed when they would be apparent to those with skill in the art so as not to obscure the description of the present system. The following detailed description is therefore not to be taken in a limiting sense, and the scope of the present system is defined only by the appended claims.

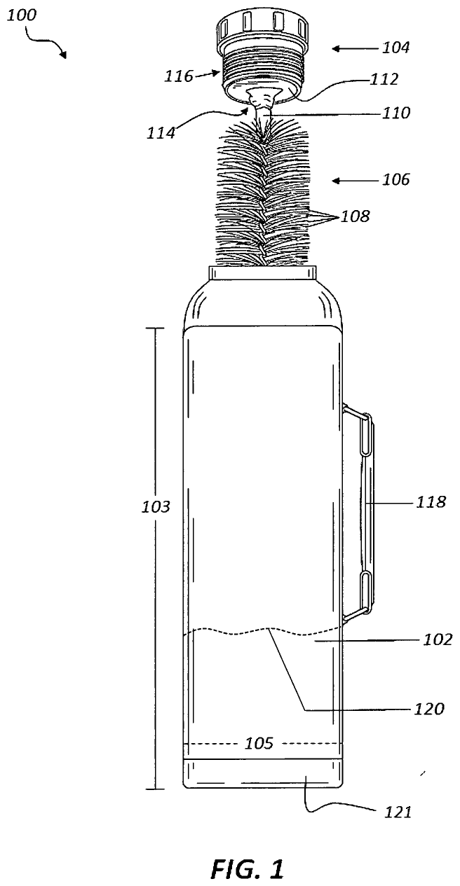

FIG. 1 shows an embodiment of a washing device 100 configured for cleaning items, for example eating utensils. The device 100 includes a cylindrical vessel, bottle or container 102, a removable cap 104, and a cleaning component 106 attached to the cap. In the example shown, the cleaning component 106 comprises an elongated brush, which includes a plurality of cleaning elements (in this specific example, bristles) 108 and a stem portion 110 coupled to the under-side of the removable cap 112 (i.e., the side that faces the interior of the container when the cap is on the container) via a coupling mechanism 114. As further shown, the removable cap 104 may be made to have a threaded portion 116 configured to engage a complementary, e.g., female, threaded portion at or near the opening of the container 102. The container 102 also includes a graspable handle 118 to facilitate user transport.

In operation, one or more items to be cleaned can be placed within the container 102, and a desired volume of water or cleaning solution, or both, can be added to the container (an example amount of cleaning liquid is depicted in the figure at 120, but any amount that will allow for effective washing may be used). The removable cap 104 can then be secured to the container 102 such that the cleaning component 106 extends therein. The device 100 can be shaken or otherwise agitated such that the items repeatedly contact bristles 108, thus cleaning the items against bristles in the water. Soap can be added at any point in the process, including to the cleaning liquid before it is added to the container. After sufficient shaking, the removable cap 104 and cleaning component 106 can be removed and the liquid poured from the container 102. In some examples, the items can be kept within the container 102 for a period of time to allow them to air-dry. In some examples, the cleaning component 106 can be uncoupled from the cap 104 after the items are removed, such that the container 102 can be used for other purposes, e.g., carrying water, coffee, soup, or other liquids.

The washing device may be used to clean various kitchen and/or eating utensils, e.g., forks, knives, spoons, etc. Items that may be cleaned using the washing device may also include things such as butcher knives, bottle openers, wine bottle openers, can openers, reusable wine corks, prongs, corn on the cob holders, chopsticks, skewers, etc. The washing device may also be used to wash items that are not associated with eating. Such items include but are not limited to various medical and/or dental tools, instruments and/or small devices used for an assortment of applications ranging from routine dental cleanings to surgical operations. For example, the inventive device may be used to clean or sterilize forceps, scalpels, scissors, clamps, mirrors, probes, scalers, curettes, etc. Other example items include hand tools and tool components used for auto-mechanical and/or construction applications. For example, the inventive device may be used to clean screwdrivers, small hammers, mallets, wrenches, sockets, pliers, etc. Various other applications will be apparent to ordinary users.

The number of items that can be cleaned simultaneously using the washing device will vary depending on the dimensions of the container 102, the size of the cleaning component 106, and the size of the items to be washed.

The dimensions of the container 102 may vary. The interior of the container 102 may define a height 103 and a maximum diameter or width 105. In some embodiments, the height 103 is at least long enough to accommodate standard eating utensils, such as dinner knives measuring about 9 inches. Accordingly, the height 103 may be at least 12 inches to allow sufficient room for such utensils to move back and forth against cleaning elements of the cleaning component for effective cleaning during the washing process. In some embodiments, the height 103 may range from about 12 to about 17 inches, about 13 to about 16 inches, about 14 to about 15 inches, or about 14.5 inches. The height 103 may also be shorter, for example ranging from about 7 to about 13 inches, about 8 to about 11 inches, or about 8.5 to about 10 inches. Such embodiments may accommodate smaller items, such as compact, portable utensils designed for traveling or camping. In some embodiments, the width 103 is kept as narrow as practicable to enable an average adult to grasp and shake the container 102 to clean the items therein without difficulty while also allowing sufficient space to accommodate multiple items for cleaning. Accordingly, the width 105 may be at least 2.5 inches. In some embodiments, the width 105 may range from about 2 to about 6 inches, about 3 to about 5 inches, or about 4 inches.

As further shown in FIG. 1, the container 102 may include a detachable base 121 in some embodiments. The detachable base 121, positioned opposite the removable cap 104, may include a threaded portion configured to engage a complementary threaded portion located on the interior surface of the container 102 in order to couple the base 121 to the container 102. The base 121 can be removed (e.g., unscrewed) by a user, thereby allowing items (and water, soap, etc.) to be added to or removed from the container 102 without removing the removable cap 104. Temporary removal of the base 121 may be especially beneficial when simultaneously cleaning a large number of items and/or one or more relatively large items by allowing a user to add such items to the container 102 with the already-inserted cleaning component 106, thereby allowing the user to carefully place the items around the cleaning component 106 without cramming the cleaning component 106 or the items therein.

In some embodiments employing a detachable base, a cleaning component may be fixed or coupled to the inward-facing side of the detachable base so that the cleaning component protrudes from the inward-facing side of the detachable base and extends into the container when the base is secured thereto. Such a cleaning component may be included in lieu of or in addition to a cleaning component protruding from the removable cap.

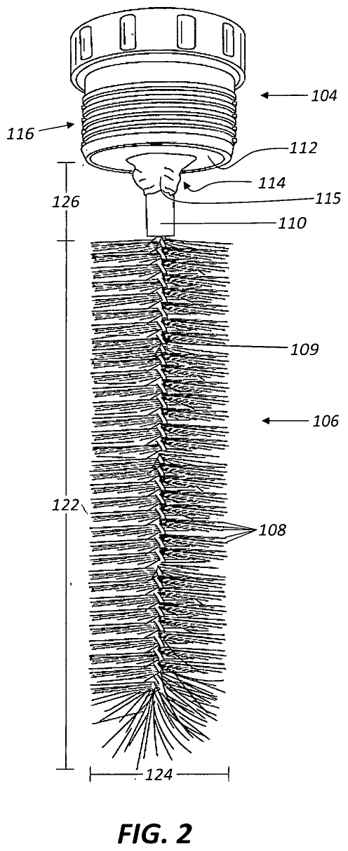

FIG. 2 shows the removable cap 104 and cleaning component 106 of FIG. 1. The configuration of the cleaning component 106 may vary. For example, the cleaning component 106 may comprise an elongated brush, which includes cleaning elements (a plurality of bristles) 108 that extend outwardly from a central rod, wire or prong 109, as shown in the embodiment depicted. Embodiments that include a brush may be configured in various ways. The bristle arrangement, for instance, may be generally uniform along the entire length of the cleaning component, may extend over only part of the length of the cleaning components, may consist of multiple, separate groupings of bristles, may be in a helical pattern, etc. Additionally, the bristles 108 may be of varying lengths, widths, or both. In some embodiments, the cleaning component 106 may include two or more prongs, such that instead of a single prong 109 lined with bristles 108, as shown, the cleaning component 106 may comprise two or more prongs each lined with cleaning elements such as a plurality of bristles.

In some embodiments, the cleaning component 106 may include one or more sponges or cloth components.

The dimensions of the cleaning component 106 may also vary. The cleaning portion of the brush shown in FIG. 2 includes a length 122 and a maximum width 124. In some embodiments, the length 122 may be about 10 to 11 inches so that that the full length of common eating utensils, including dinner knives, would contact the cleaning elements of the cleaning component during the washing process. In some embodiments, the length 122 may be about 12 to 13 inches so that the full length of common eating utensils as well as items such as large butcher knives would contact the cleaning component during the washing process. In some embodiments, the length 122 may be about 14 to 15 inches so that the full length of common eating utensils, butcher knives and most skewers would contact the cleaning component during the washing process. In some embodiments, the length of the cleaning component may be longer or shorter than the lengths listed above depending on the size of the items to be washed. For example, the length 122 may range from about 6 to about 14 inches, about 8 to about 12 inches, about 9 to about 11 inches, or about 10 inches. In some examples, the length 122 may be at least half as long as the height 103 of the internal washing chamber defined by the container 102, and may be up to about 50%, 60%, 70%, 80%, 90%, 95% or 100% as long as the height 103 of the container 102. In some embodiments, the length 122 may range from about 60% to about 80% of the height 103 of the container.

The maximum width 124 of the cleaning component should be such the bristles would sufficiently contact any item in the washing device during the process of shaking or agitating the container 102. The width 124 may be approximately halfwide, or at least half as wide, as the maximum width 105 of the container 102, and may be up to about 50%, 60%, 70%, 80%, 90%, 95% or 99% as wide as the maximum width 105 of the container 102, such that items placed therein may not avoid contact with the cleaning component 106 by remaining near the perimeter of the container 102. In some embodiments, the width 124 may be about 50% to about 80% of the maximum width 105 of the container 102. In some embodiments, the width 124 may range from about 1 to about 4 inches, about 2 to about 3 inches, about 2.25 to about 2.75 inches, or about 2.5 inches. The width 124 may be adjusted depending on the mode of operation of the washing device 100. For example, if the washing device is shaken or agitated to wash items placed therein, the width 124 of the cleaning component 106 may be narrower than a washing device that is not shaken or agitated during cleaning. Washing devices that include rotatable or plunger-like cleaning components, for example, may require a cleaning component having a greater maximum width to ensure that all items are contacted during cleaning.

The configuration of the stem portion 110 may also vary. The stem portion 110 may be comprised of various materials, e.g., one or more polymers, metals, stainless steel, etc., and may be rigid or flexible. The stem portion length 126 may range from about 0.25 to about 2.0 inches, about 0.5 to about 1.5 inches, about 0.75 to about 1.25 inches, or about 1 inch. The width of the stem portion 110 may be greater than the width of the prong 109. In some embodiments, the stem portion 110 may be detachable from the remainder of the cleaning component 106, such that differently-sized stem portions may be included as part of the cleaning component, which may allow the same brush, for instance, to be used with containers 102 having different depths.

The coupling mechanism 114 may also vary. In the embodiment shown, the coupling mechanism 114 includes an adhesive 115, e.g., glue, securing the stem portion 110 to the under-side 112 of the removable cap 104. In addition or alternatively, the stem portion 110 may be inserted into an aperture defined by the removable cap 104, thereby anchoring the stern portion to the removable cap. Accordingly, the cleaning component 106, via the stem portion 110, may be permanently attached to the removable cap 104 in some embodiments. In some embodiments, the cleaning component 106 may be coupled with the removable cap 104 in such a way that it can be easily coupled and uncoupled.

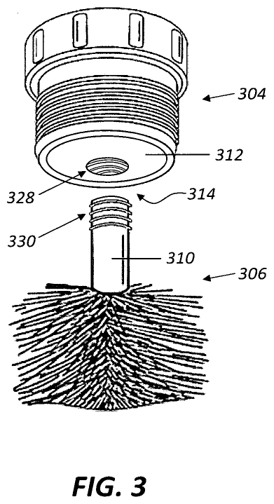

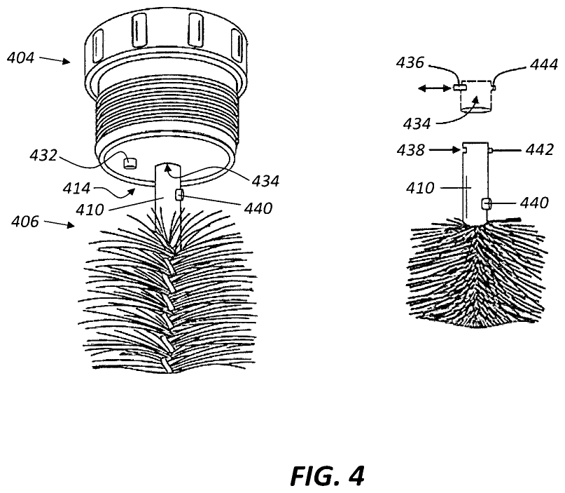

FIGS. 3 and 4 show example coupling mechanisms implemented in accordance with embodiments of the present disclosure. In FIG. 3, a coupling mechanism 314 includes an internally threaded aperture 328 defined by a removable cap 304 such that the opening of the aperture 328 is located at the under-side 312 of the removable cap 304. The aperture 328 is configured to engage a complementary externally threaded portion 330 defined by an end of a stem portion 310 of cleaning component 306. To couple the cleaning component 306 with the removable cap 304, the stern portion 310 can be screwed into the aperture 328.

In FIG. 4, the coupling mechanism 414 includes a release mechanism 432 configured to alternate the removable cap 404 between locked and unlocked configurations. In this example, the stem portion 410 of cleaning component 406 is insertable into an aperture 434 defined by the removable cap 404. The aperture 434 may be configured similarly to the aperture 328 shown in FIG. 3, but without the threaded interior surface. The release mechanism 432, which in this example comprises a push-button, can be depressed to allow insertion of the stem portion 410 into the removable cap 404, and then released to lock the stem portion 410 within the removable cap 404. To release the stem portion 410 from the removable cap 404, the release mechanism 432 can be pressed or otherwise actuated, and the stem portion 410 pulled or allowed to fall from the aperture 434. The internal configuration of the release mechanism 432 may vary. For example, the release mechanism 432 may include or be coupled with a bidirectionally movable internal latch or pin 436 component (in the direction of the arrows) configured to engage a recess or slot 438 defined by the stem portion 410. Upon release of the release mechanism 432, the latch component 436 may extend outwardly, into the complementary slot 438, thereby locking the cleaning component 406 with the removable cap 404. In additional examples, the stem portion 410 may include a release mechanism 440. Actuating the release mechanism 440, e.g., pressing the bush-button shown, may retract a latch component 442 protruding near the end of the stem portion 410, thereby allowing insertion of the stem portion 410 into the aperture 434, where the latch component 440 may slide into a complementary slot or recess 444 defined by the aperture 434, thereby locking the stem portion 410 with the removable cap 404. The latch components 436, 442 may biased, e.g., spring-loaded, toward their respective receiving slots 438, 444 such that the coupling mechanism 414 is biased toward the locked configuration.

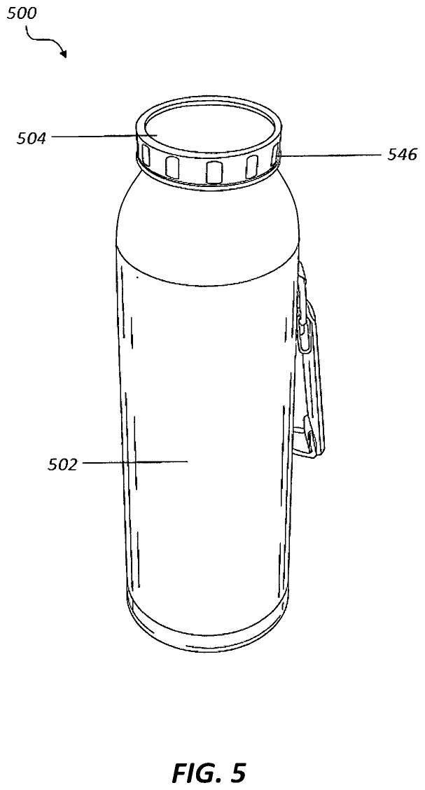

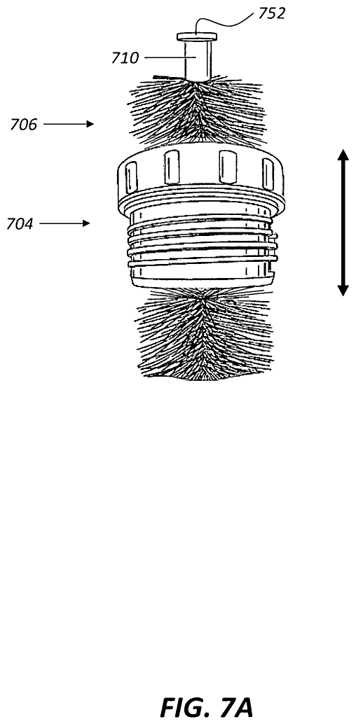

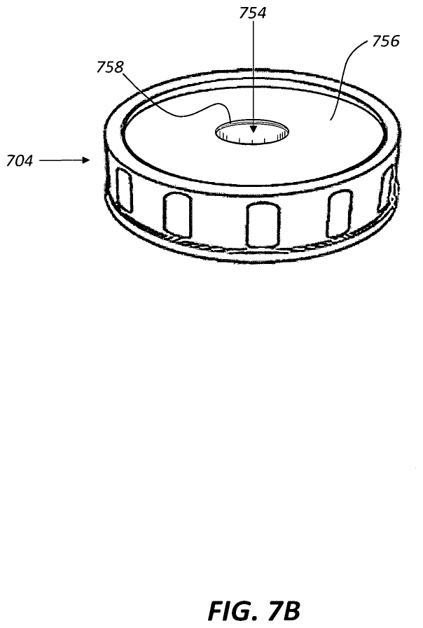

FIG. 5 shows a washing device 500 in a closed configuration. The container 502 is sealed by a removable cap 504. The removable cap 504 may include an engagement texture 546 configured to facilitate manual gripping of the removable cap 504. In the example shown, the user engagement texture 546 comprises a plurality of depressions defined by an external surface of the cap 504. As further shown in FIG. 5, the cleaning component may not be visible on the external surfaces of the cap and the container. In some embodiments, the cleaning component may be partially visible through the top surface of the cap and/or may extend through the cap (see FIG. 7). The container 502 and the removable cap 504 may be comprised of various materials, e.g., one or more polymers, metals, stainless steel, etc.

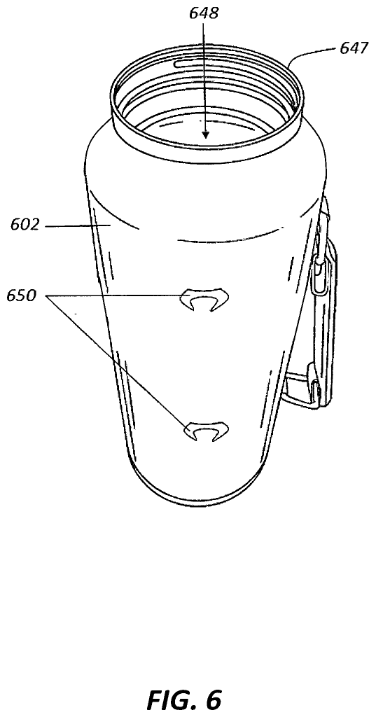

FIG. 6 shows an open container 602 in accordance with one or more embodiments herein. As shown, the container 602 defines a round aperture 647 and an internal cavity 648 or washing chamber configured to receive a plurality of items to be cleaned, a cleaning component, and various liquids. The volume of the cavity 648 (in fluid ounces) may vary, for example ranging from about 16 to about 80 oz., about 20 to about 68 oz., about 32 to about 48 oz., about 60 to about 75 oz., about 65 to about 70 oz., or about 68 oz. Larger volumes, e.g., between about 60 and about 70 oz., may be preferred to simultaneously wash as many items as possible. The diameter of the aperture 647 may also vary, and in some embodiments, may be approximately equal to or slightly larger than the maximum width of a cleaning component inserted therethrough (e.g., width 124 of cleaning component 106). Diameters less than the width of the cleaning component may cause water, soap and dirt to be sprayed into the air upon removal of a cleaning component from the container 602. The container 602 also includes an external attachment mechanism 650, e.g., one or more flexible clips, straps or clamps, configured to hold and store a cleaning component, for example by coupling to the stem portion thereof. By coupling a cleaning component to the outside of the container 602 via the external attachment mechanism 650, the cleaning component can air-dry while not in use.

FIG. 7A shows a removable cap 704 and a cleaning component 706 extending therethrough in accordance with embodiments of the present disclosure. To accommodate passage of the cleaning component 706, the removable cap 704 may define a through-hole. A cap 752 may be included at an end of the stem portion 710 of the cleaning component 706 to seal the through-hole after full insertion of the cleaning component 706 into a receiving container. An example through-hole 754 is shown in FIG. 7B exposed at a top surface 756 of the removable cap 704. The cross-sectional shape and dimensions of the through-hole 754 may vary. In some embodiments, the diameter of the through-hole 754 may be approximately equal to or smaller than the width of the cleaning component such that in embodiments featuring a brush, the bristles may be forced to flex during passage through the through-hole. As further shown, the through-hole 754 may define a shelf or ledge 758 configured to support the cap 752, thereby preventing over-insertion of the cleaning component into the through-hole 754 and container. Embodiments may also include one or more additional sealing components, e.g., O-rings, to further seal the through-hole 754.

In operation, the cleaning component 706 can be repeatedly inserted and removed from a container, e.g., container 102, in plunger-like fashion to facilitate cleaning items placed in the container. In addition or alternatively, the cleaning component 706 can be docked within the through-hole 754, for example by resting the cap 752 on the shelf 758, and the container into which the cleaning component protrudes can be shaken or agitated as described in connection with the washing device 100 shown in FIG. 1. A user can also clean the items by rotating the cleaning component 706 via the cap 752.

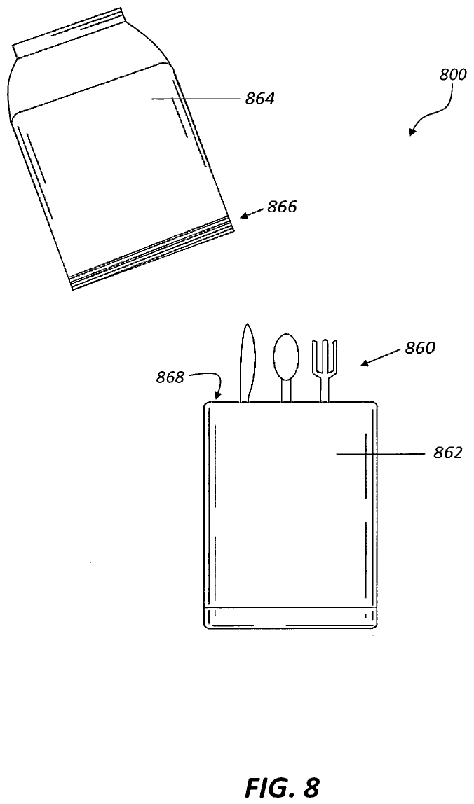

FIG. 8 shows another washing device 800 configured to clean various items 860. The device 800 includes two main parts. Depending on orientation, the first part 862 may comprise the bottom part, and the second part 864 may comprise the upper part. The first and second parts 862, 864 may be coupled such that the second part 864 can be readily uncoupled from the first part 862, as shown. The first and second parts 862, 864 may define complementary threaded portions 866, 868 for coupling and uncoupling, similar to the threaded portions shown in FIG. 3. One threaded portion may be internally defined and one may be externally defined. The multi-part configuration of the washing device 800 may facilitate removal of the items 860 by exposing at least a portion thereof after removal of the second part 864. The height of the first part 862 may vary, ranging from about 4 to about 10 inches, about 4 to about 8 inches, about 4.5 to about 6 inches, or about 5 inches in various embodiments. After washing the items 860, a user can remove the water from the container and the second part 864 from the first part 862, and thereafter leave the items 860 to air-dry together in a single, organized space, which may be particularly useful when flat drying surfaces, e.g., tabletops, are limited. The washing device 800 may also be coupled with a removable cap, such as the removable cap 104 shown in FIG. 1, and a cleaning component, e.g., cleaning component 106, coupled thereto for washing the items in the manner described herein.

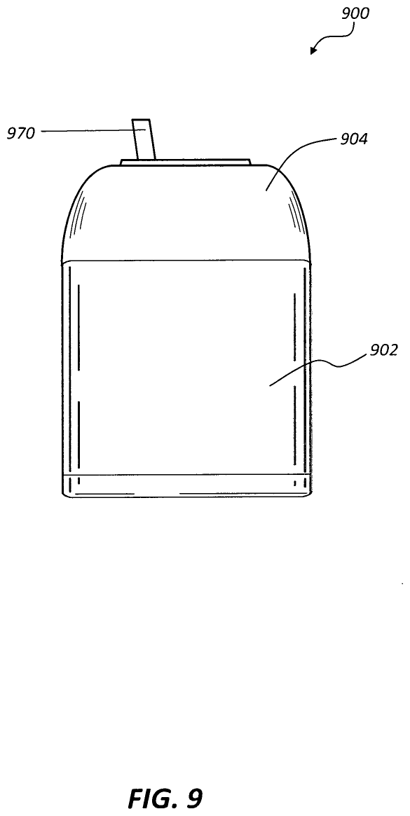

FIG. 9 shows another washing device 900 comprised of a container 902 coupled with a removable lid or cap 904. As shown, the size and shape of the washing devices described herein may vary. The washing device 900 is wider and more curved than washing device 100, for example, and includes a straw portion 970 protruding from the cap. Additional washing devices may be rectangular, irregular, or square.

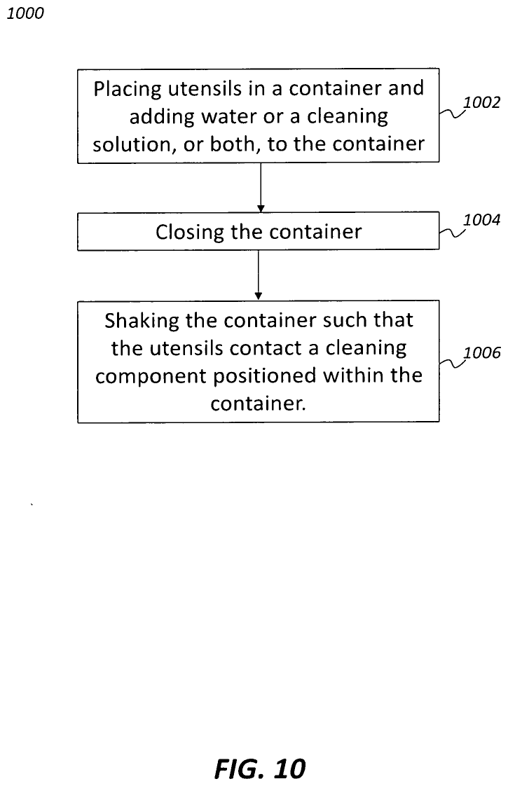

FIG. 10 illustrates an example method 1000 of washing items (in this example, utensils) in accordance with the present disclosure. The example method 1000 shows the steps that may be utilized, in any sequence, by the systems and/or apparatuses described herein for washing various utensils, for example outside a household or in households lacking traditional dishwashing equipment.

In the embodiment shown, the method 1000 begins at block 1002 by “placing utensils in a container and adding water or a cleaning solution, or both, to the container.” The type and number of utensils may vary and may depend on the capacity of the container used. In some embodiments, at least 1 and up to 50 or more utensils may be simultaneously placed within the container. The utensils may be dirty, for example from being used to cook or eat food. Various additional utensils can also be added to the container, such as utensils comprised of plastic, metal or wood, including for example utensils typically used during outdoor activities such as camping. Water can be added before, after, or at the same time as the utensils. In some embodiments, a removable cap may be used to close and seal the container after adding the utensils and water thereto. Although not shown in FIG. 10, soap can also be used. Select embodiments of the removable cap may include a soap reservoir and mechanism for injecting soap into the container. According to such embodiments, soap may be added to the container after it is closed. The volume of water may depend on the number of utensils being washed. For example, a greater number of utensils may require a greater volume of water. In some examples, the volume of water added may range from about 10 to about 60 oz., about 20 to about 40 oz., or about 30 to about 35 oz.

At block 1004, the method may involve “closing the container.” In some examples, the container may be closed with a removable component, such as a removable cap. According to such examples, the cleaning component may be reversibly or permanently coupled with the removable cap, as described herein, and may comprise an elongated brush configured to contact the utensils.

At block 1006, the method may involve “shaking the container such that the utensils contact a cleaning component positioned within the container.” In additional or alternative embodiments, the container may be held stationary while only the cleaning component is moved. According to such embodiments, the cleaning component can be, for example, rotatable and/or configured to move in a plunger-like fashion.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A device configured for washing utensils, the device comprising:
a container;
a removable cap coupled to the container; and
a cleaning component protruding within the container.

2. The device of claim 1, wherein the cleaning component comprises an elongated brush.

3. The device of claim 1, wherein the container comprises a bottle.

4. The device of claim 1, wherein the cleaning component is coupled to the under-side of the removable cap.

5. The device of claim 1, wherein the cleaning component is reversibly coupled to the under-side of the removable cap.

6. The device of claim 5, wherein the cleaning component comprises a stem portion comprising a threaded portion configured to engage a complementary threaded portion defined by the removable cap.

7. The device of claim 5, wherein said coupling is male-female type.

8. The device of claim 5, wherein the cleaning component comprises a male stem portion and the removable cap comprises a female portion configured to receive all or part of the stem portion.

9. The device of claim 1, wherein the removable cap defines a through-hole configured to allow the cleaning component to move through the through-hole.

10. The device of claim 9, wherein the cleaning component comprises a cap at one end, wherein the cap is configured to close the through-hole upon insertion of the cleaning component into the container.

11. The device of claim 1, wherein the container comprises a detachable base.

12. The device of claim 11, wherein the cleaning component comprises an elongated brush.

13. The device of claim 11, wherein the cleaning component is coupled to the inward-facing side of the detachable base.

14. A component for washing utensils, the component comprising:
a cap configured to be coupled to a container; and
a cleaning component coupled to the under-side of the cap such that the cleaning component will protrude within a container when the cap is coupled thereto.

15. The component of claim 14, wherein the cleaning component comprises an elongated brush.

16. A method of washing utensils, the method comprising:
placing utensils in a container and adding water or a cleaning solution, or both, to the container;
closing the container; and
shaking the container such that the utensils contact a cleaning component positioned within the container.

17. The method of claim 16, wherein the cleaning component comprises an elongated brush.

18. The method of claim 16, wherein the cleaning component is coupled to the inward-facing side of a removable component coupled to the container.

19. The method of claim 18, wherein the cleaning component comprises a stem portion comprising a threaded portion configured to engage a complementary threaded portion defined by the removable component.

20. The method of claim 18, wherein the coupling of the cleaning component to the inward-facing side of the removable component is male-female type.
